(19) United States
(12) Patent Application Publication
(10) Pub. No.: US 2025/0136331 A1
(43) Pub. Date: May 1, 2025

(54) SYSTEMS AND METHODS FOR AN INSULATING CONTAINER

(71) Applicant: PRIDE MANUFACTURING COMPANY, LLC, Brentwood, TN (US)

(72) Inventors: John Robert Burt, Brentwood, TN (US); Randon Kruse, Sheridan, WY (US); Danny Meador, College Grove, TN (US)

(21) Appl. No.: 18/730,654

(22) PCT Filed: Jan. 26, 2023
(86) PCT No.: PCT/US2023/061394

§ 371 Date: Jul. 19, 2024

Related U.S. Application Data
(60) Provisional application No. 63/303,155, filed on Jan. 26, 2022.

(51) Int. Cl. B65D 45/28; B65D 25/28; B65D 53/02; B65D 81/38

(52) U.S. Cl. CPC B65D 45/28; B65D 25/2873; B65D 53/02; B65D 81/3813

(57) ABSTRACT

Various embodiments of an insulating container that includes a lid configured for engagement with a housing for water leak protection. The housing and lid each respectively define a first angled surface and a second angled surface. When coupled, the first and second angled surfaces collectively define a shell interference that seals the container to prevent immediate leakage of fluid. Further, the insulating container includes a gasket that contacts a shelf portion of the housing, collectively defining a gasket interference that further seals the insulating container to prevent immediate leak-age.

### CROSS-REFERENCE TO RELATED APPLICATIONS

This a PCT Patent Application that claims benefit to U.S. Provisional Patent Application No. 63/303,155 filed 26 Jan. 2022, which is herein incorporated by reference in its entirety.

### FIELD

The present disclosure generally relates to insulating containers, and in particular, to a system and associated method for an insulating container with a dual-contact seal configuration.

### BACKGROUND

Existing products use waterproof zippers to provide leak resistance. Many of these zippers are extremely difficult to use since it takes a significant amount of strength or gripping power to close many of these types of zippers. As such, a less cumbersome but leak resistant product is desired. It is with these observations in mind, among others, that various aspects of the present disclosure were conceived and developed.

### BRIEF DESCRIPTION OF THE DRAWINGS

FIG. 1 is a perspective view showing a first embodiment of an insulating container;

FIG. 2 is a cutaway perspective view showing the insulating container of FIG. 1;

FIG. 3 is a top view showing the insulating container of FIG. 1;

FIG. 4 is a front view showing the insulating container of FIG. 1;

FIG. 5 is a cross-sectional side view showing the insulating container taken along line 5-5 of FIG. 4;

FIG. 6 is an enlarged cross-sectional side view showing the insulating container taken along circle 6 of FIG. 5;

FIG. 7 is an enlarged cross-sectional side view showing the insulating container taken along circle 7 of FIG. 5;

FIG. 8 is a perspective view showing a lid of the insulating container of FIG. 1;

FIG. 9 is a top view showing the lid of FIG. 8;

FIG. 10 is a cross-sectional view showing the lid taken along line 10-10 of FIG. 9;

FIG. 11 is an enlarged cross-sectional view showing the lid taken along circle 11 of FIG. 10;

FIG. 12 is a cross-sectional view showing the lid taken along line 12-12 of FIG. 9;

FIG. 13 is a bottom view showing the lid of FIG. 8;

FIG. 14 is a perspective view showing a housing of the insulating container of FIG. 1;

FIG. 15 is a top view showing the housing of FIG. 14;

FIG. 16 is a cross-sectional side view showing the insulating container taken along line 16-16 of FIG. 15;

FIG. 17 is a cross-sectional side view showing the insulating container taken along line 17-17 of FIG. 15;

FIG. 18 is an enlarged cross-sectional view showing the housing taken along circle 18 of FIG. 16;

FIG. 19 is a bottom view showing the housing of FIG. 14;

FIG. 20 is a front view showing a loop element of the insulating container of FIG. 1;

FIG. 21 is a side view showing the loop element of FIG. 20;

FIGS. 22A-22D are a series of views showing a hook element of the insulating container of FIG. 1;

FIG. 23 is a perspective view showing a second embodiment of an insulating container;

FIG. 24 is a cross-sectional view showing the insulating container of FIG. 23;

FIG. 25 is an enlarged view showing the fastener assembly of the insulating container of FIG. 23;

FIG. 26 is an enlarged cross-sectional view showing the fastener assembly of the insulating container of FIG. 23;

FIG. 27 is a perspective view showing a third embodiment of an insulating container;

FIG. 28 is a cross-sectional side view showing the insulating container taken along line 28-28 of FIG. 27;

FIG. 29 is a cross-sectional side view showing the insulating container taken along line 29-29 of FIG. 27;

FIG. 30 is an enlarged cross-sectional view showing the insulating container taken along circle 30 of FIG. 29;

FIG. 31 is a perspective view showing a fourth embodiment of an insulating container;

FIG. 32 is a cutaway perspective view showing the insulating container of FIG. 31;

FIG. 33 is an enlarged cross-sectional side view showing engagement of a lid with a housing of the insulating container of FIG. 31:

FIG. 34 is a front view showing the insulating container of FIG. 31 with a lid decoupled from a housing;

FIG. 35 is a cross-sectional side view showing the insulating container taken along line 35-35 of FIG. 34;

FIG. 36 is an enlarged view showing a loop element of the insulating container of FIG. 31; and

FIG. 37 is a rear view showing the insulating container having carrying straps, including shoulder straps.

Corresponding reference characters indicate corresponding elements among the view of the drawings. The headings used in the figures do not limit the scope of the claims.

### DETAILED DESCRIPTION

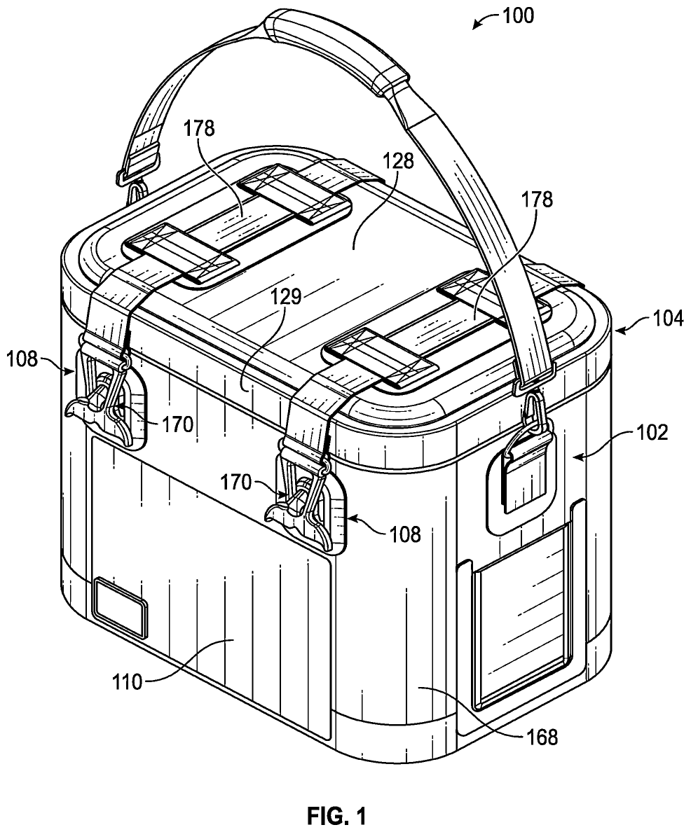

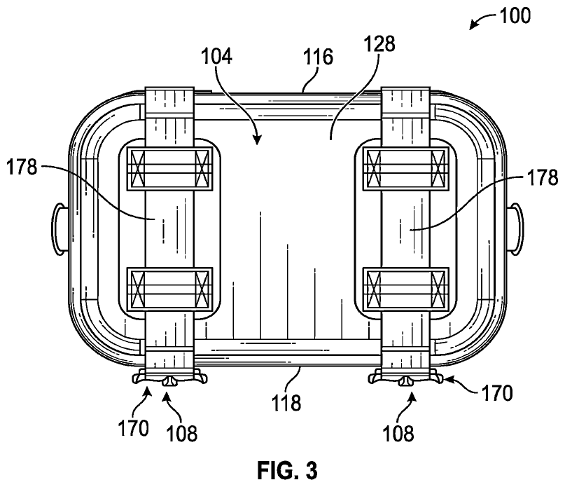

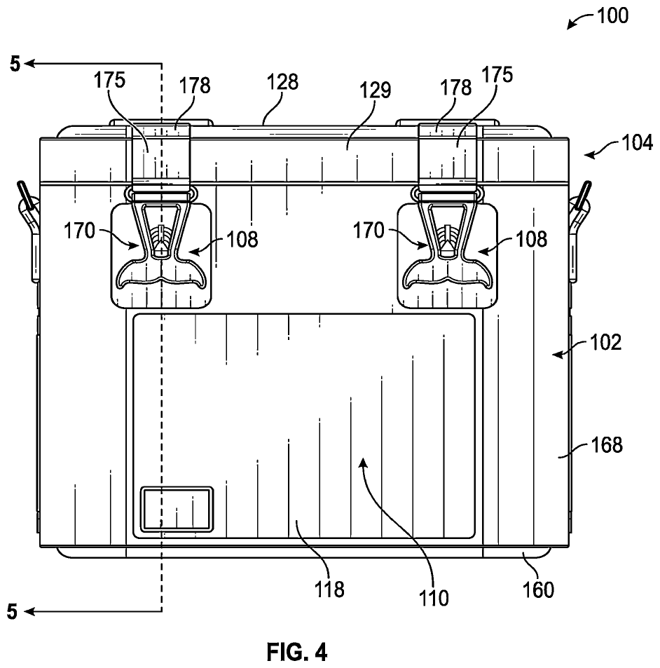

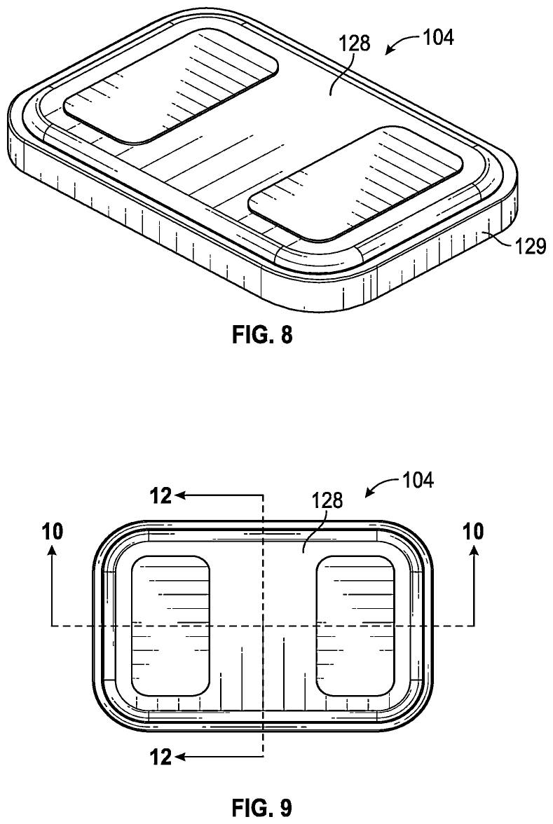

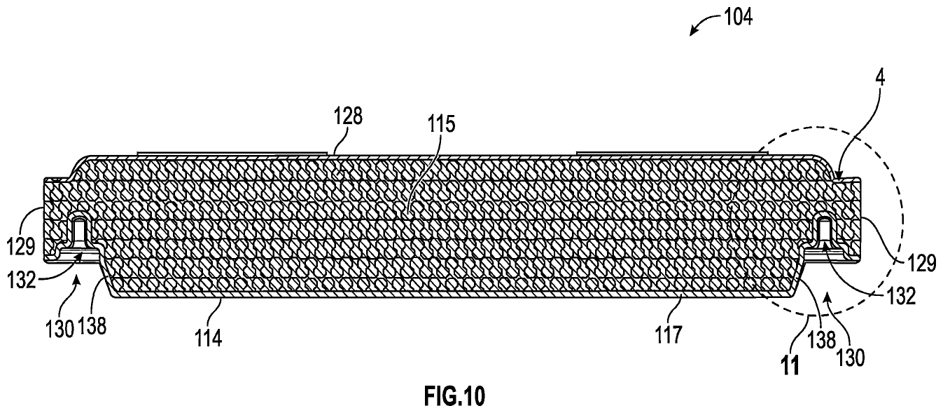

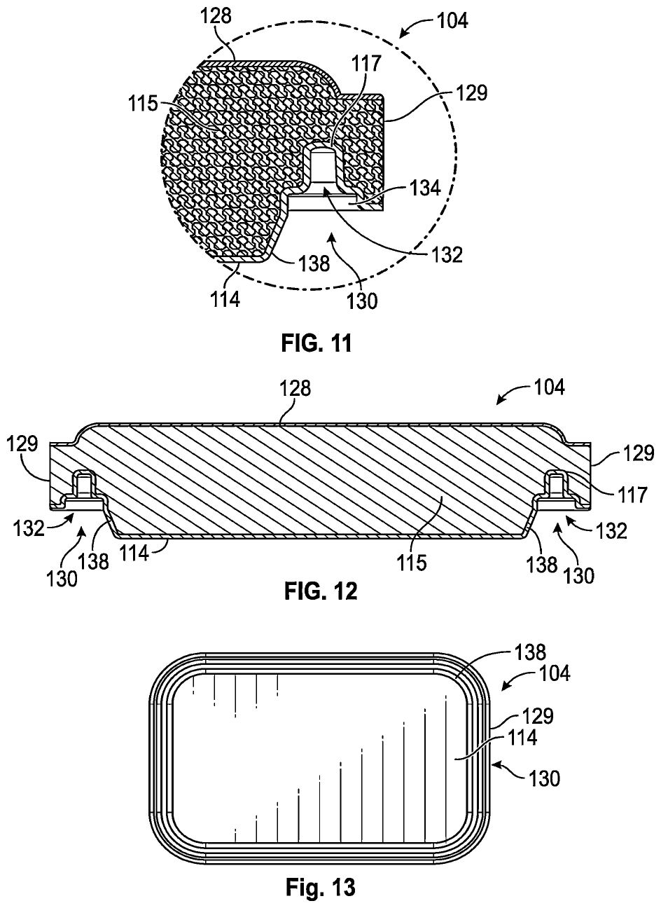

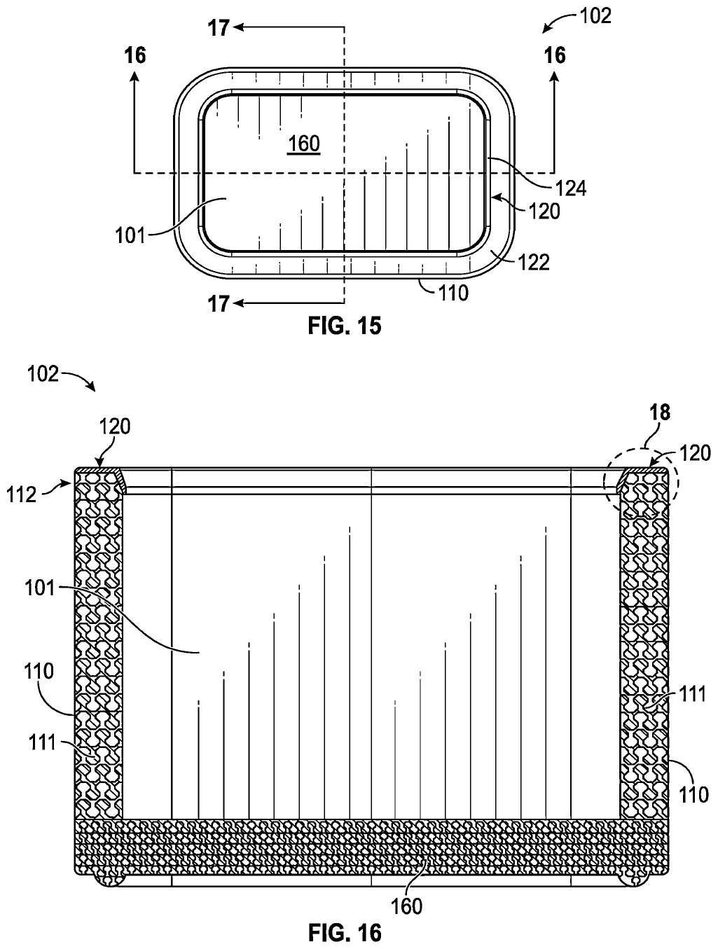

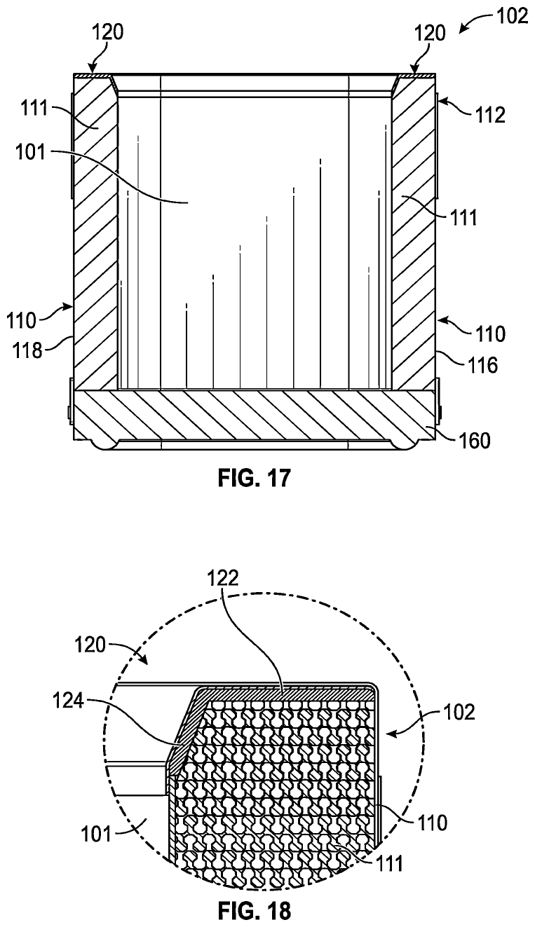

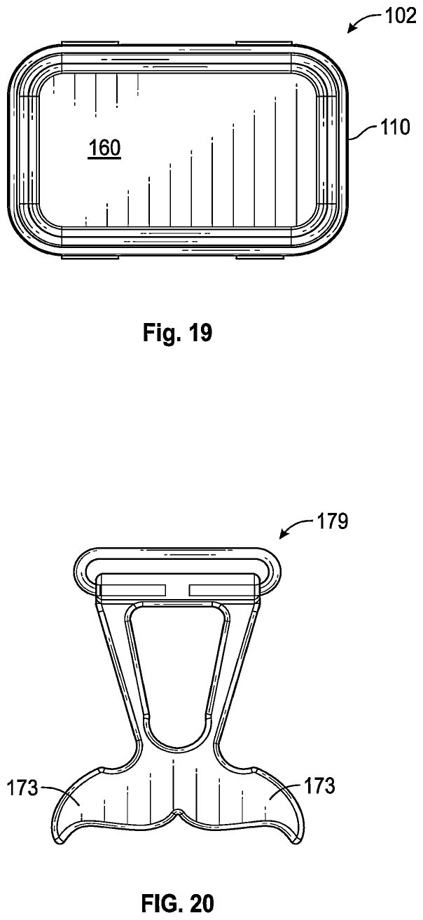

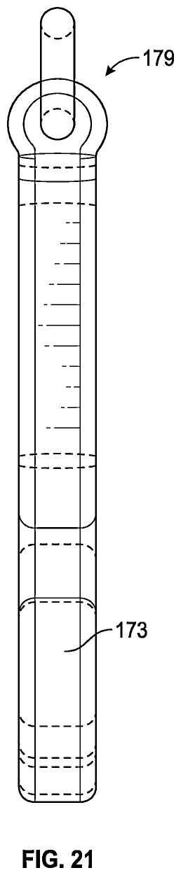

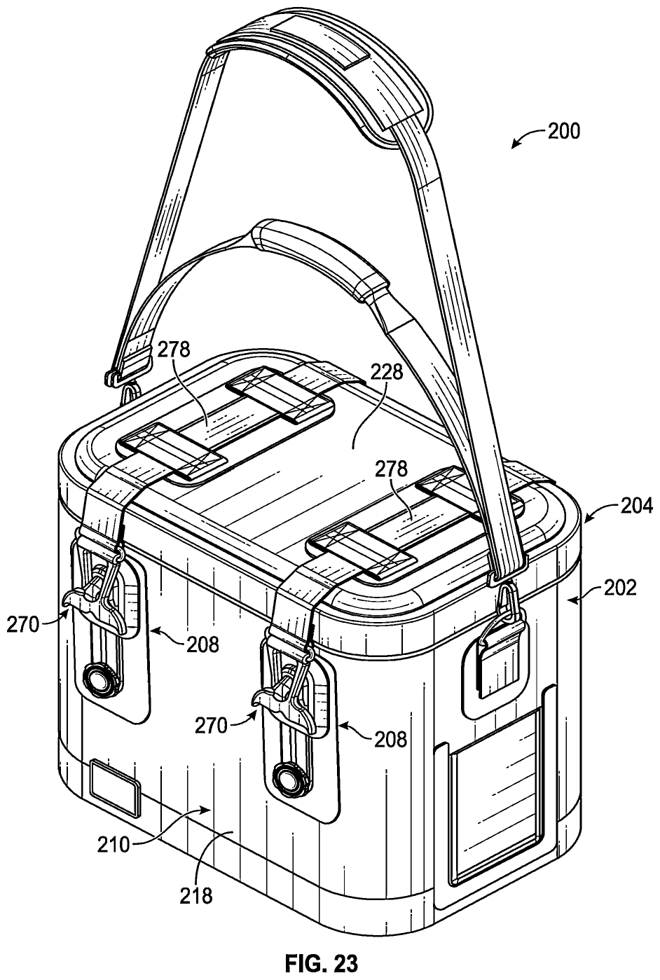

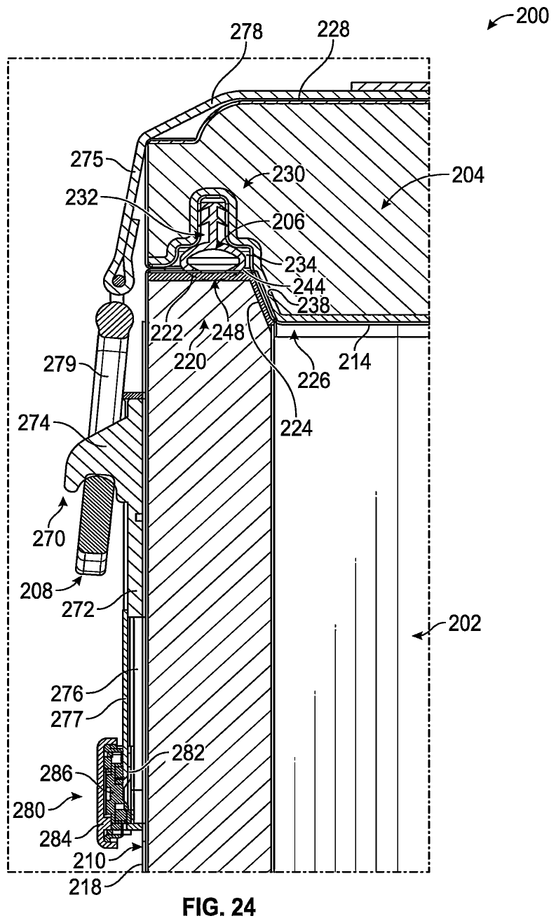

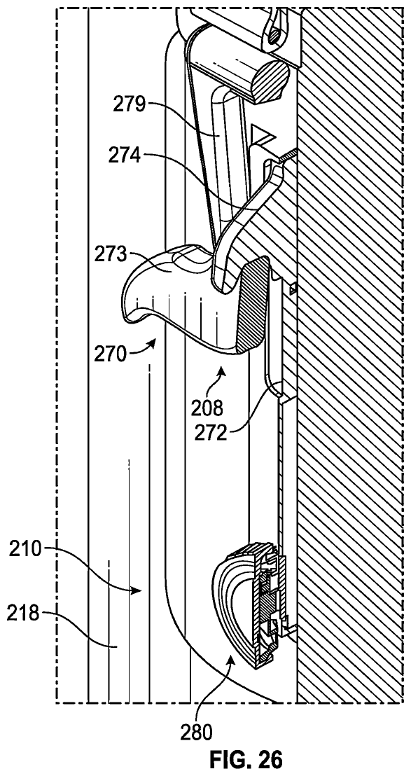

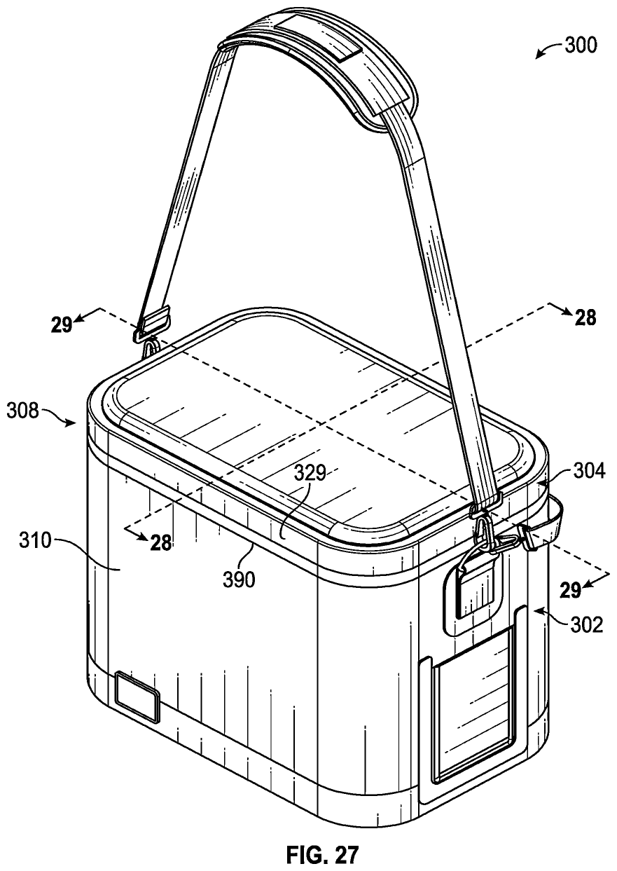

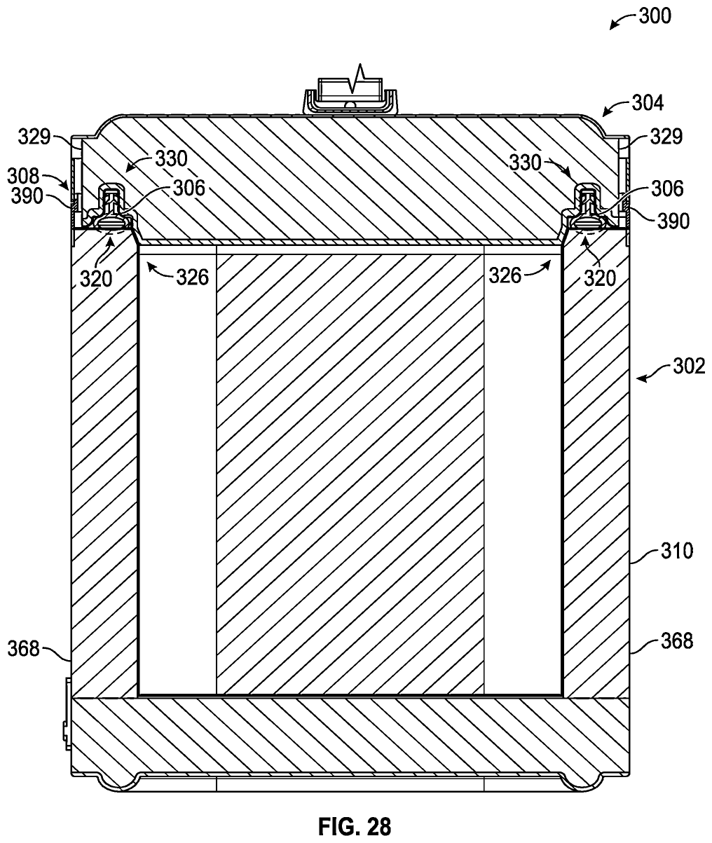

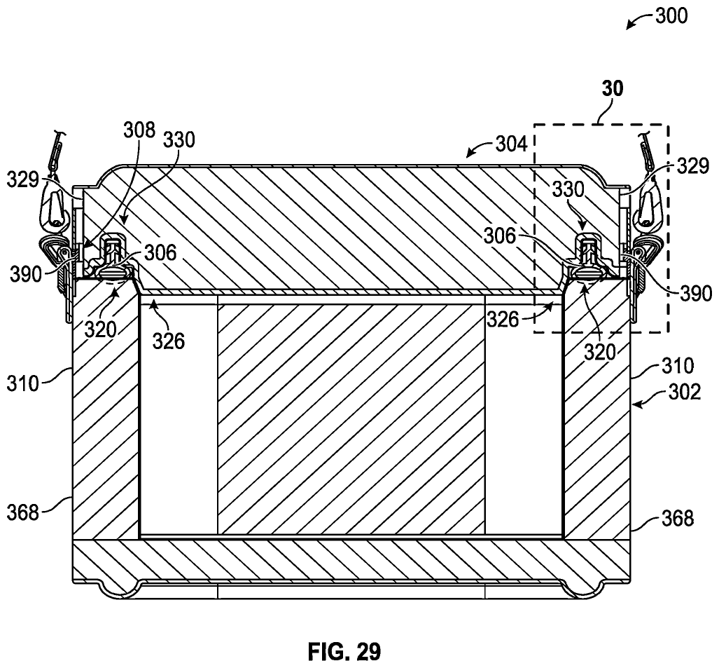

Various embodiments of an insulating container are described herein. In particular, the insulating container includes a housing forming a sidewall and a first engagement region defined at an open portion of the sidewall. The open portion of the insulating container is configured for engagement with a lid which includes a second engagement region defined circumferentially about an interior surface of the lid. The first engagement region includes a shelf portion in association with a gasket and a first angled surface defined interior to the shelf portion. The second engagement region includes a gasket channel, wherein the gasket channel is configured to receive the gasket to couple the gasket to the lid. The second engagement region further includes a second angled surface defined interior to the gasket channel and configured to engage the first angled surface of the housing. The first angled surface and the second angled surface collectively define a shell interference that seals the insulating container to prevent immediate leakage. The gasket contacts the shelf portion at a first side of the gasket, collectively defining a gasket interference. Referring to the drawings, embodiments of an insulating container having a dual-seal configuration are illustrated and generally indicated as 100 in FIGS. 1-22D, 200 in FIGS. 23-26, 300 in FIGS. 27-30, and 400 in FIGS. SI-37.

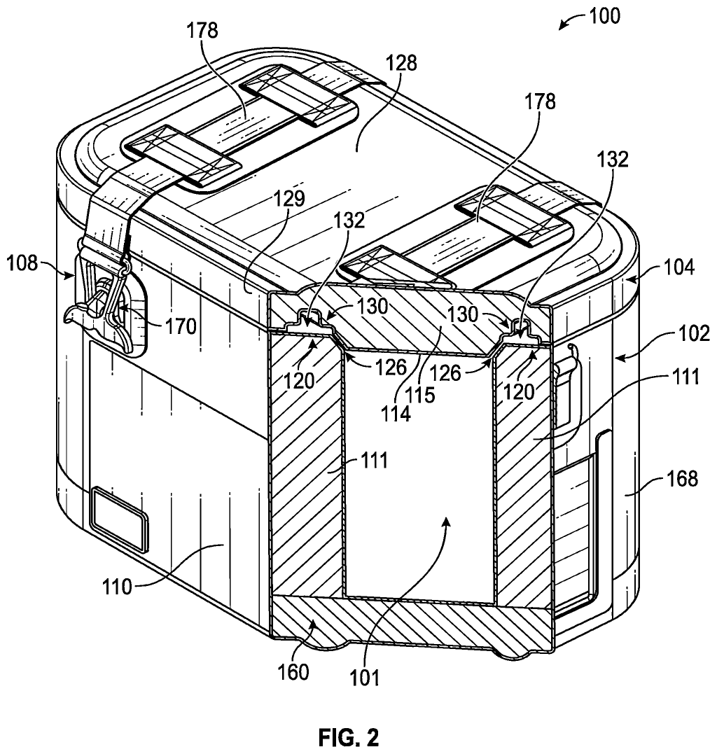

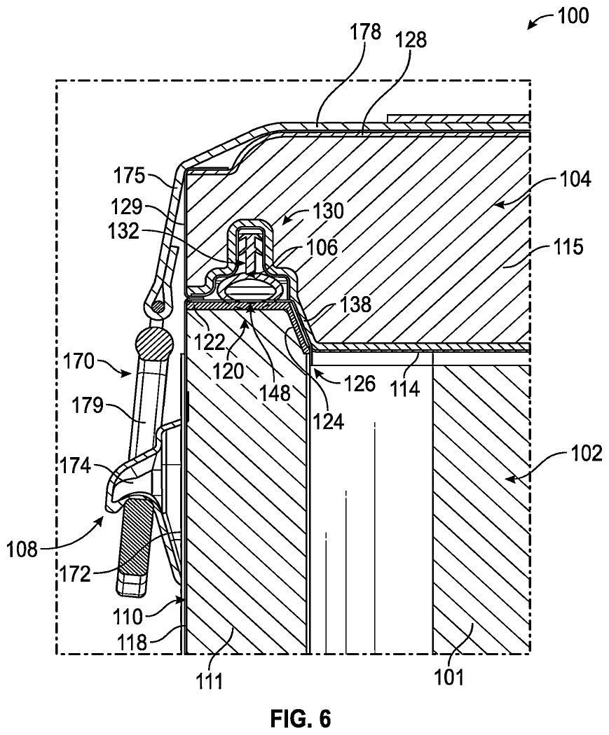

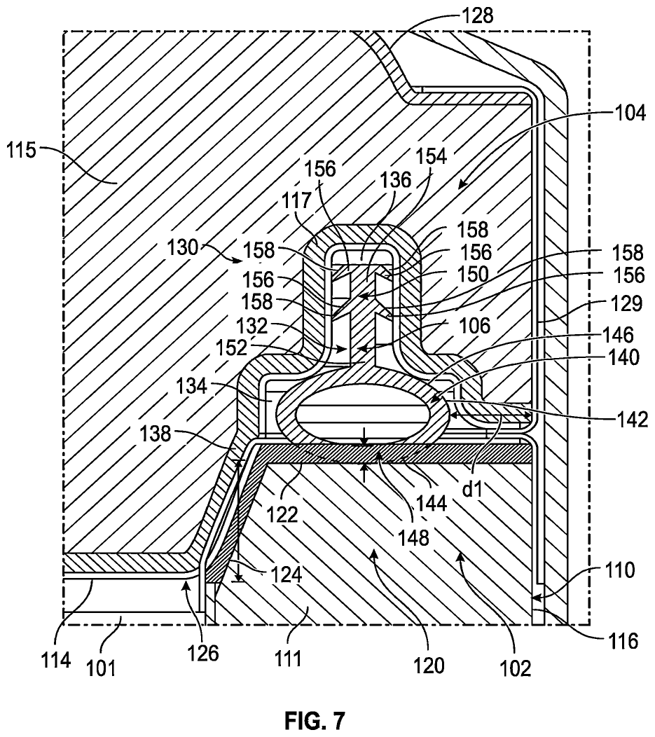

Referring to FIGS. 1-7, the insulating container 100 includes a housing 102 defining a sidewall 110 encapsulating a cavity 101 (FIG. 2). The sidewall 110 defines an open portion 112 in communication with the cavity 101 that defines a first engagement region 120 for receipt of a lid 104, as shown in FIG. 2. The lid 104 further defines a second engagement region 130 on an interior surface 114 of the lid 104 that engages the first engagement region 120 of the housing 102 and forms a seal between the lid 104 and the housing 102. Referring to FIGS. 6 and 7, The lid 104 and the housing 102 are joined at a gasket 106 that seals the cavity 101 of the insulating container 100. The gasket 106 is defined circumferentially about the lid 104 and defines a first side 144 that forms a seal between the lid 104 and the housing 102. The first engagement region 120 of the housing 102 and the second engagement region 130 of the lid 104 collectively define a dual-seal configuration that prevents immediate leakage of fluids.

In particular, the first engagement region 120 of the housing 102 defines a shelf portion 122 that contacts the first side 144 of the gasket 106 which creates a gasket interference 148 defining a vertical interference between the gasket 106 and the housing 102 to seal the gasket 106 against the housing 102. The second engagement region 130 of the lid 104 includes a gasket channel 132 defining a wide section 134 configured to house the gasket 106. In particular, the wide section 134 receives the gasket 106 to further create an additional point-of-contact between the gasket 106 and the lid 104. In addition, the housing 102 includes a first angled surface 124 defined interior to the shelf portion 122, and the lid 104 includes a second angled surface 138 defined interior to the gasket channel 132. The second angled surface 138 is configured to engage the first angled surface 124 of the housing 102 such that a shell interference 126 defining a vertical interference is defined between the first angled surface 124 and the second angled surface 138 to seal the lid 104 against the housing 102.

In some embodiments such as the embodiment of FIGS. 1-22D, the insulating container 100 is fastened by a fastener assembly 108 including a hook element 170 in association with a strap 178. In other embodiments such as the embodiment of FIGS. 23-26, an insulating container 200 is fastened by a fastener assembly 208 including an additional tensioning device 280 embedded within a channel 276 and in further association with a strap 278 and a hook element 270 for improved sealing of a lid 204 against a corresponding housing 202. In a third embodiment shown in FIGS. 27-30, an insulating container 300 is fastened by a fastener assembly 308 including a zipper 390 extending circumferentially along an exterior surface 368 of a sidewall 310.

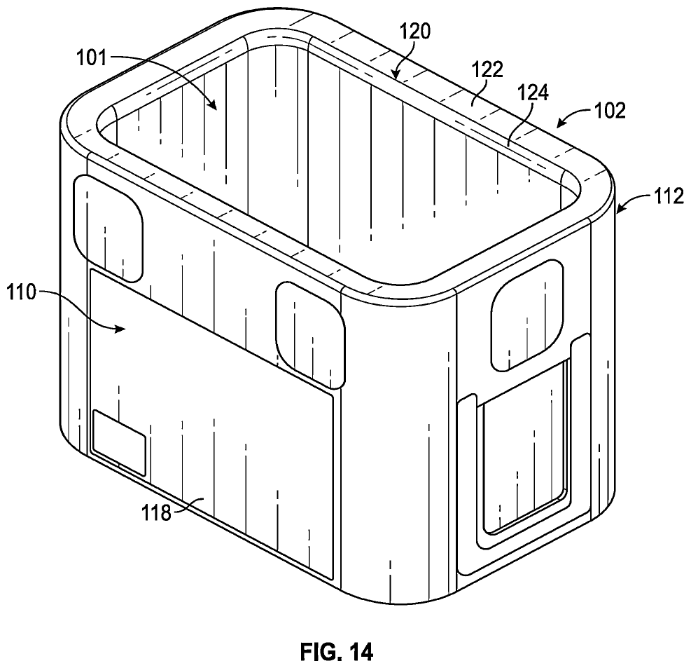

Referring to FIGS. 14-22D, the housing 102 of the insulating container 100 defines the sidewall 110 encapsulating the cavity 101. The sidewall 110 defines an exterior surface 168, which includes a distal exterior surface 116 and a proximal exterior surface 118 defined opposite to the distal exterior surface 116. The sidewall 110 further defines the open portion 112 of the housing 102 that communicates with the cavity 101 and defines the first engagement region 120. The first engagement region 120 of the housing 102 is configured for engagement with the second engagement region 130 of the lid 104 to form a robust seal with multiple established points of interference. Further, the housing 102 includes a base 160 in association with the sidewall 110 that defines the lower portion of the cavity 101 to store items within the cavity 101 of the insulating container 100. As shown, the first engagement region 120 is defined circumferentially about the entire open portion 112 of the sidewall 110 of the housing 102.

In particular, the first engagement region 120 defines the shelf portion 122 in association with the gasket 106 for receipt of the first side 144 of the gasket 106, as specifically illustrated in FIG. 6. The shelf portion 122 is also shown without the gasket 106 in FIGS. 14-22D. The shelf portion 122 generally defines a flat surface for engagement with the first side 144 of the gasket 106. The gasket 106 and shelf portion 122 form the gasket interference 148 that defines the vertical interference. Further, the first engagement region 120 includes the first angled surface 124 defined interior to the shelf portion 122 that defines a decline into the cavity 101 of the housing 102. The first angled surface 124 is configured to engage the second angled surface 138 of the lid 104 to form a seal between the lid 104 and the housing 102. In a primary embodiment, a degree of incline/decline of the first angled surface 124 is 70 degrees, however various ranges are also contemplated. In addition, the vertical interference of the shell interference 126 is greater than the vertical interference of the gasket interference 148. This ensures proper centering and compression of the sidewall 110 when coupling the lid 104 with the housing 102 in a press-seal engagement. The fastener assembly 108 and lid 104 provide enough downforce to properly compress the gasket 106 against the housing 102 to prevent water seepage from the cavity 101. In some embodiments, a body material 111 of the sidewall 110 of the housing 102 includes a first material that can in some embodiments be an insulating material.

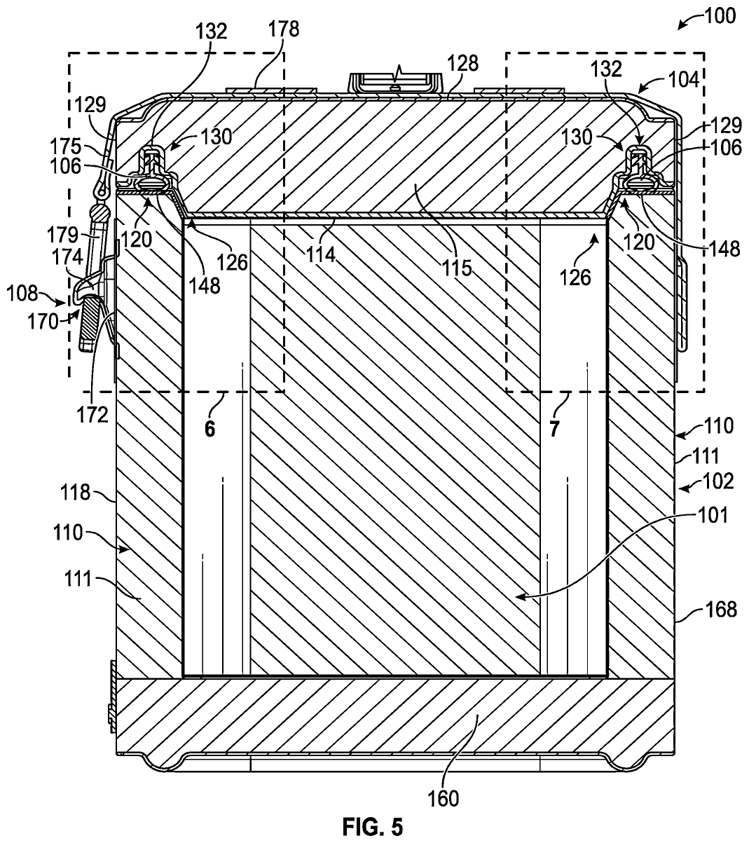

Referring to FIGS. 5-13, the lid 104 is configured for engagement with the open portion 112 of the sidewall 110 of the housing 102. The lid 104 defines the interior surface 114 that spans the open portion 112 of the housing 102 to seal the cavity 101 when the lid 104 is coupled with the housing 102 in a press-seal engagement. The lid 104 defines the second engagement region 130 circumferentially around the interior surface 114 of the lid 104 as shown. Further, the lid 104 defines an exterior surface 128 that additionally defines an exterior peripheral surface 129.

The second engagement region 130 is configured for engagement with the first engagement region 120 of the housing 102, described above. As shown, the second engagement region 130 defines the gasket channel 132 for receipt of the gasket 106. The second engagement region 130 further includes a second angled surface 138 defined interior to the gasket channel 132 and configured to engage the first angled surface 124 of the housing 102 such that a seal is defined between the first angled surface 124 and the second angled surface 138. The second angled surface 138 is configured to engage the first angled surface 124 of the housing 102 to form the shell interference 126 between the lid 104 and the housing 102. In a primary embodiment, a degree of incline/decline of the second angled surface 138 is 70 degrees to match the incline/decline of the first angled surface 124, however various ranges are also contemplated. As discussed above, the vertical interference of the shell interference 126 is greater than the vertical interference of the gasket interference 148. This ensures proper centering and compression of the sidewalls 110 when coupling the lid 104 with the housing 102 in a press-seal engagement. As shown, the second angled surface 138 extends below the gasket channel 132. In some embodiments, a body material 115 of the lid 104 includes a first material that can in some embodiments be an insulating material. Further, as shown, the second engagement region 130 of the lid 104 includes a second material layer 117 including a second material and covering the body material 115 at the interior surface 114 of the lid 104.

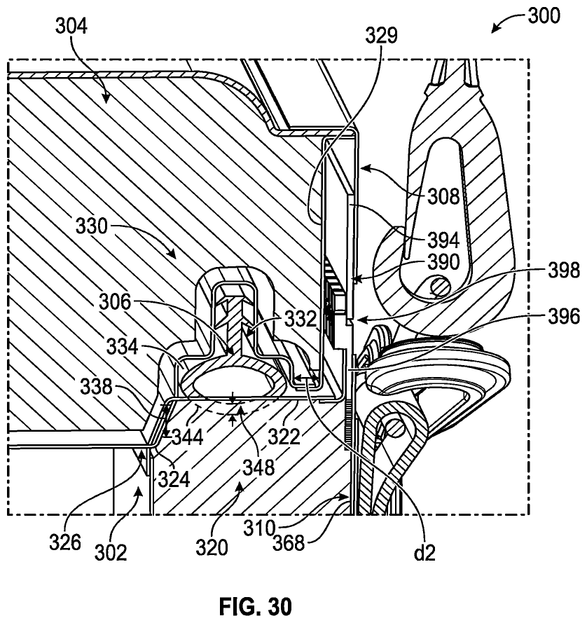

In some embodiments such as in the case of the insulating container 300 shown in FIG. 30, a distance d2 between the gasket channel 332 and the exterior peripheral surface 329 can be shorter than that of the insulating container 100 (di, FIG. 7) to enable alignment of a zipper 390 with the exterior surface 368 of the sidewall 310.

Referring to FIG. 7, in one example embodiment, the gasket 106 includes a tubular portion 140 that defines an exterior surface 142. The exterior surface 142 further defines the first side 144 that contacts the shelf portion 122 of the first engagement region 120 to form the gasket interference 148. The exterior surface 142 of the tubular portion 140 additionally defines a second side 146 opposite from the first side 144 that contacts the wide section 134 of the gasket channel 132, defining a point-of-contact between the wide section 134 of the gasket channel 132 and the tubular portion 140 of the gasket 106. In a preferred embodiment, the tubular portion 140 is deformable to enable sealing flexibility.

In some embodiments, the gasket 106 further includes a spine 150 extending from the second side 146 of the tubular portion 140 that engages with an upper niche section 136 of the gasket channel 132 of the lid 104. In some embodiments, the spine 150 is removably coupled within the upper niche section 136. The spine 150 defines a proximal portion 152 associated with the tubular portion 140, and further defines a distal portion 154 that includes a plurality of tangs 156. Each tang 156 of the plurality of tangs 156 includes a respective free end 158 that frictionally or adhesively engages a surface of the upper niche section 136. As shown, each free end 158 is angled towards the tubular portion 140 of the gasket 106 for added stability within the upper niche section 136 of the gasket channel 132. In some embodiments, the gasket 106 includes a deformable and water-proof material.

FIGS. 5-7 illustrate the engagement of the gasket 106, lid 104 and housing 102 of the insulating container 100. As shown and as previously discussed, the second engagement region 130 of the lid 104 defines the gasket channel 132 circumferentially about the interior surface 114 of the lid 104 that forms the wide section 134 and the upper niche section 136 which communicates with the wide section 134. The gasket channel 132 is configured to receive the gasket 106. The second side 146 of the gasket 106 contacts the surface of the wide section 134 as the lid 104 compresses against the housing 102. The housing 102 defines the first engagement region 120 that includes the shelf portion 122 that receives the first side 144 of the exterior surface 142 of the tubular portion 140 of the gasket 106. The shelf portion 122 of the housing 102 and first side 144 of the gasket 106 collectively define the gasket interference 148.

Further, the first engagement region 120 and the second engagement region 130 each include their respective first angled surface 124 and second angled surface 138. The first angled surface 124 is defined interior to the shelf portion 122 of the first engagement region 120 and engages the second angled surface 138 of the second engagement region 130. The second angled surface 138 extends interior to and below the gasket channel 132. When coupled together, the first angled surface 124 and the second angled surface 138 form the shell interference 126 between the first angled surface 124 and the second angled surface 138. The vertical interference of the shell interference 126 is greater than the vertical interference of the gasket interference 148.

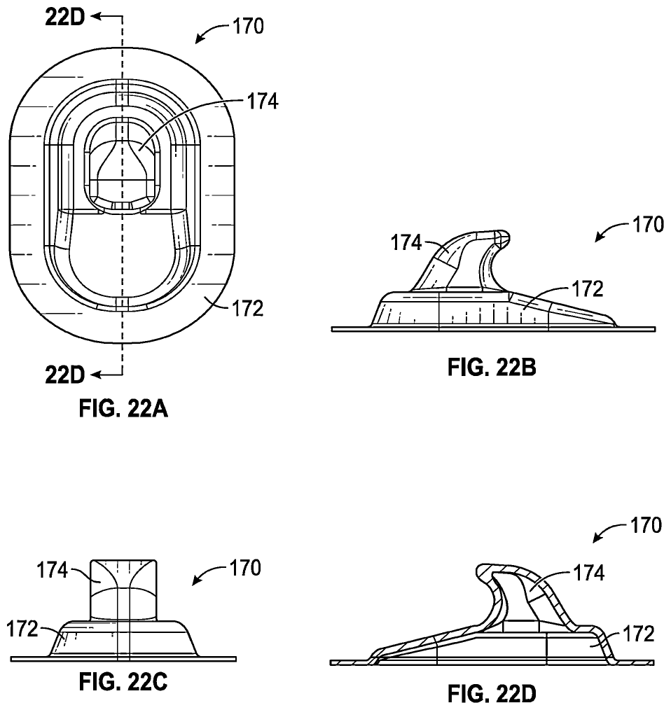

Referring to FIGS. 1, 3-5, 7, and 20-22D, the insulating container 100 is fastened by a fastener assembly 108 including a hook element 170 in association with a strap 178. The strap 178 is configured to span the exterior surface 128 of the lid 104. In some embodiments, the strap 178 spans from the distal exterior surface 116 of the sidewall 110, across the exterior surface 128 of the lid 104, and terminates at the proximal exterior surface 118 of the sidewall 110. The strap 178 includes a loop element 179 at a free end 175 of the strap 178. The loop element 179 is configured for coupling and decoupling from the hook element 170, which in some embodiments is fixed to the proximal exterior surface 118 of the sidewall 110. As shown, in some embodiments the loop element 179 includes a pair of flange elements 173 located on each lateral side of the loop element 179 for grasping and pulling the strap 178 to engage and decouple from the hook element 170. As shown in FIGS. 22A-22D, the hook element 170 includes a hook base 172 that is in some embodiments fixed directly to the proximal exterior surface 118 of the sidewall 110 of the housing 102. The hook base 172 defines a hooked portion 174 that engages the loop element 179 directly when fastening the insulating container 100 shut.

In other embodiments such as the embodiment of FIGS. 23-26, an insulating container 200 is fastened by a fastener assembly 208 including an additional tensioning device 280 embedded within a channel 276 and in further association with a strap 278 and a hook element 270 for improved sealing of a lid 204 (analogous to lid 104) against the housing 202. Likewise, the strap 278 is configured to span an exterior surface 228 of the lid 204. In some embodiments, similar to the strap 178 (FIG. 1) the strap 278 spans from a distal exterior surface (not shown) of a sidewall 210 of a housing 202 (analogous to housing 102), across the exterior surface 228 of the lid 204, and terminates at a proximal exterior surface 218 of the sidewall 210. The strap 278 includes a loop element 279 at a free end 275 of the strap 278. The loop element 279 is configured for coupling and decoupling from the hook clement 270, which in some embodiments is slidably mounted within a channel 276 defined at the proximal exterior surface 218 of the sidewall 210. As shown, in some embodiments the loop element 279 includes a pair of flange elements 273 located on each lateral side of the loop element 279 for grasping and pulling the strap 278 to engage and decouple from the hook element 270. The hook element 270 includes a hook base 272 that is slidably mounted within the channel 276. The hook base 272 defines a hooked portion 274 that engages the loop element 279 directly when fastening the insulating shut. The hook base 272 can be further coupled with a tensioning element 277 that is disposed within the channel 276 that terminates at a tensioning device 280 configured for tensioning and/or detensioning the tensioning element 277. The channel 276 is in vertical alignment with the strap 278.

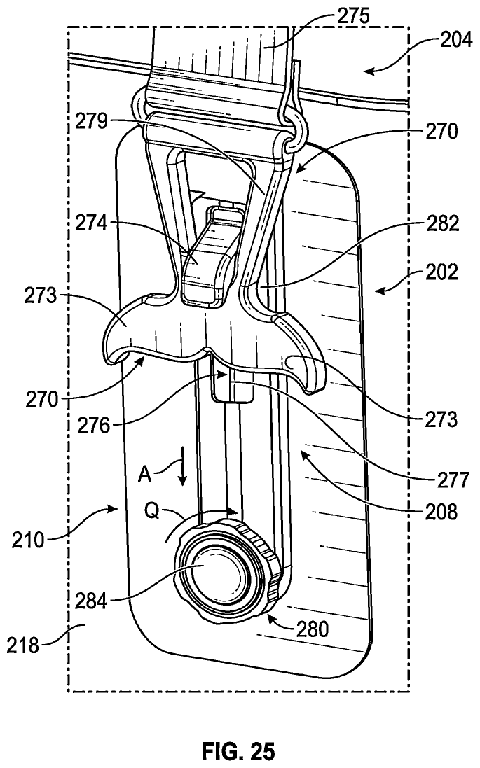

Tensioning the tensioning element 277 by operation of the tensioning device 280 causes the hook base 272, and by extension the strap 278, to be pulled in a first axial direction A (FIG. 25). In some embodiments, the tensioning device 280 includes a base 282 and a dial 284 at least partially encapsulating a spool 286 rotatable by the dial 284. The base 282 is fixed within the channel 276 of the sidewall 210, and the spool 286 engages the tensioning element 277 to wind the tensioning element 277 about the spool 286 wherein rotation of the dial 284 in a first rotational direction Q tensions the tensioning element 277 and pulls the hook base 272 downwards in the first axial direction A. If the loop element 279 is coupled with the hook element 270, then the associated strap 278 can be further tightened to improve the seal between the lid 204 and the housing 202.

In another embodiment, the tensioning device 280 can include a quick-release strap mechanism (not shown) that includes a ridged strap (not shown) defining a plurality of ridges (not shown). The tensioning device 280 can further include a buckle assembly (not shown) that includes a moveable tang (not shown); the moveable tang engages the ridged strap at one of the plurality of ridges to tension and secure the ridged strap.

The insulating container 200 includes a gasket 206 analogous to gasket 106 of the insulating container 100, as well as a respective first engagement region 220 of the housing 202 and a second engagement region 230 along an interior surface 214 of the lid 204 analogous to that of the insulating container 100. In particular, the first engagement region 220 of the housing 202 defines a shelf portion 222 that contacts the gasket 206 which creates a gasket interference 248 defining a vertical interference between the gasket 206 and the housing 202. The gasket 206 is defined circumferentially about the lid 204 and similarly defines a first side 244 that forms a seal between the lid 204 and the housing 202 when coupled with the first engagement region 220 of the housing 202.

The second engagement region 230 of the lid 204 includes a gasket channel 232 defining a wide section 234. The wide section 234 receives the gasket 206 to further create an additional point of contact between the gasket 206 and the lid 204. In addition, the housing 202 includes a first angled surface 224 defined interior to the shelf portion 222, and the lid 204 includes a second angled surface 238 defined interior to the gasket channel 232. The second angled surface 238 is configured to engage the first angled surface 224 of the housing 202 to define a shell interference 226 defining a range between the first angled surface 224 and the second angled surface 238. The vertical interference of the shell interference 226 is greater than the vertical interference of the gasket interference 248.

In a third embodiment shown in FIGS. 27-30, an insulating container 300 is fastened by a fastener assembly 308 including the zipper 390 defined circumferentially about an exterior surface 368 of a sidewall 310.

It should be noted that the embodiment of the insulating container 300 includes a gasket 306 analogous to gasket 106 of the insulating container 100, as well as a respective first engagement region 320. The second engagement region 330 is mostly analogous to the second engagement region 130 that of the insulating container 100; a notable exception being a distance d2 between the gasket channel 332 and the exterior peripheral surface 329 can be shorter than that of the insulating container 100 (di shown in FIG. 7) to enable vertical alignment of the zipper 390 with the exterior surface 368 of the sidewall 310, as specifically shown in FIG. 30. In other words, the shelf portion 322 can be significantly wider than the second engagement region 330 of the lid 304 to enable space outside the gasket channel 332 for the zipper 390. As shown in FIG. 30, the teeth 398 of the zipper 390 are aligned with the exterior peripheral surface 329 of the lid 304. The zipper 390 includes a first tape 394 coupled to the exterior peripheral surface 329 of the lid 304 and a second tape 396 coupled to the exterior surface 368 of the sidewall 310, the first and second tape 394 and 396 being operable for coupling at the plurality of teeth 398 by a slider element (not shown). The zipper 390 does not need to be waterproof, as the dual-seal configuration of the first engagement region 320 and the second engagement region 330 ensures that water leakage is prevented.

The first engagement region 320 of the housing 302 defines a shelf portion 322 that contacts the gasket 306 which creates gasket interference 348 defining a vertical interference between the gasket 306 and the housing 302. The gasket 306 is defined circumferentially about the lid 304 and similarly defines a first side 344 that forms a seal between the lid 304 and the housing 302 when coupled with the first engagement region 320 of the housing 302.

The second engagement region 330 of the lid 304 includes a gasket channel 332 defining a wide section 334. The wide section 334 receives the gasket 306 to further create a point-of-contact between the gasket 306 and the lid 304. In addition, the housing 302 includes a first angled surface 324 defined interior to the shelf portion 322, and the lid 304 includes a second angled surface 338 defined interior to the gasket channel 332. The second angled surface 338 is configured to engage the first angled surface 324 of the housing 302 such that a shell interference 326 defining a vertical interference is defined between the first angled surface 324 and the second angled surface 338. The vertical interference of the shell interference 326 is greater than the vertical interference of the gasket interference 348.

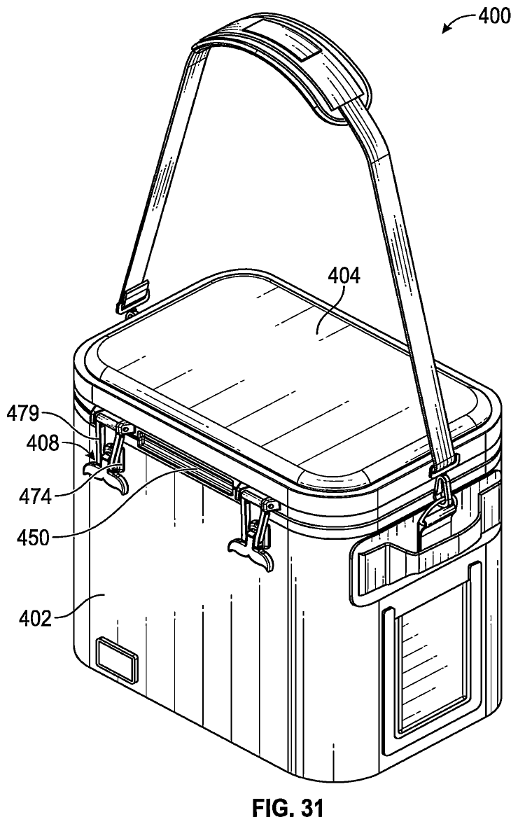

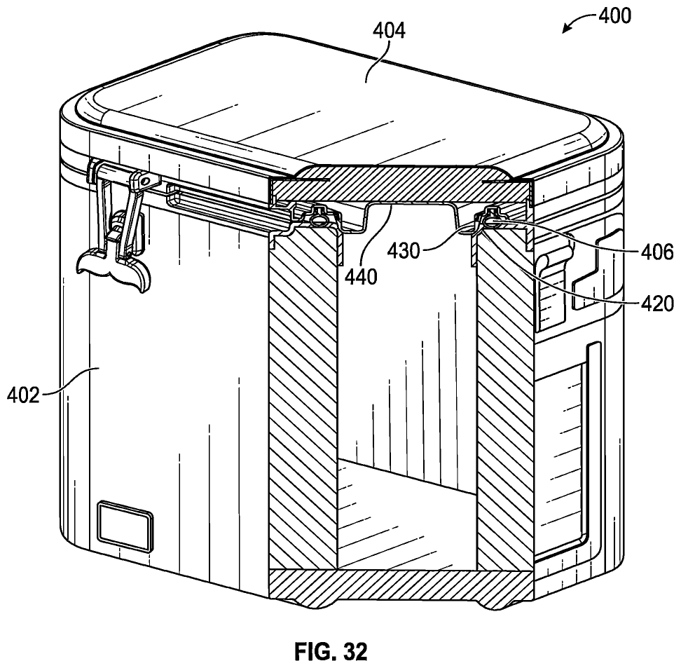

In a fourth embodiment shown in FIGS. 31-37, an insulating container 400 includes a lid 404 that couples directly with a housing 402 at a fastener assembly 408. As shown in FIGS. 31 and 32, and in contrast to previously-discussed embodiments, loop elements 479 couple or are otherwise formed along a front surface of the lid 404 such that, when engaged with respective hooked portions 474 along a front surface of the housing 402, the lid 404 compresses against housing 402 as shown.

Further, in some examples, the lid 404 and the housing 402 collectively define a gripping region 450 that provides a space for a user to grasp the lid 404 and lift the lid 404 away from the housing 402. As shown, gripping region 450 can define a recess along a front surface of the insulating container 400.

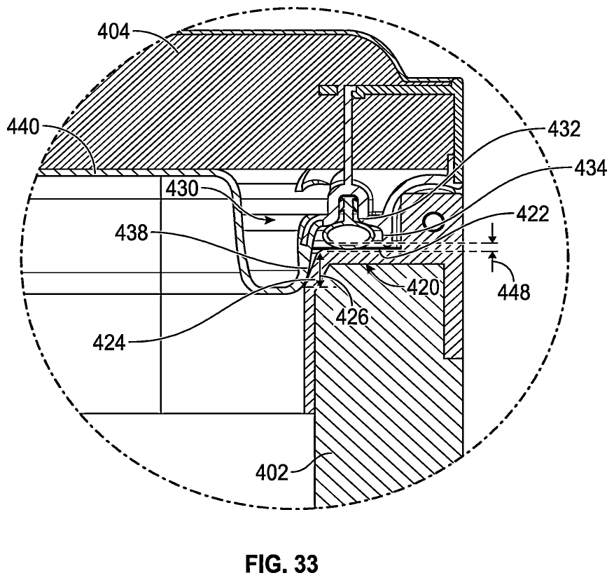

The insulating container 400 includes a gasket 406 positioned within a gasket channel 432 of the lid 404, as well as a first engagement region 420 along the housing 402 and a second engagement region 430 along the lid 404. As shown in FIG. 33, the first engagement region 420 of the housing 402 can couple with the second engagement region 430 of the lid 404 at a shell interference 426 defining a vertical interference. The housing 402 includes a first angled surface 424 of the first engagement region 420 that engages the lid 404 at a second angled surface 438 of the second engagement region 430 defined interior to the gasket channel 432. In some embodiments, the first engagement region 420 and/or the second engagement region 430 can include a rubberized or otherwise elastomeric surface that improves a seal therebetween. In contrast to previous embodiments, the lid 404 can include a raised ceiling 440 positioned interior to the second engagement region 430 that increases an internal capacity of the insulating container 400 while still providing substantial engagement with the first engagement region 420 of the housing 402.

Further, the first engagement region 420 of the housing 402 can include a shelf portion 422 that contacts the gasket 406 which creates gasket interference 448 defining a vertical interference between the gasket 406 and the housing 402. The second engagement region 430 of the lid 404 includes the gasket channel 432 defining a wide section 434. The wide section 434 receives the gasket 406 to further create a point-of-contact between the gasket 406 and the lid 404. The vertical interference of the shell interference 426 is greater than the vertical interference of the gasket interference 448.

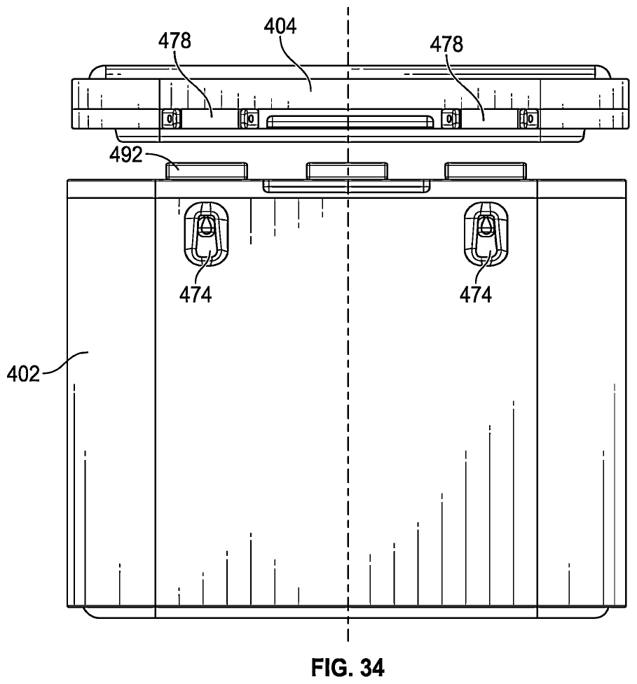

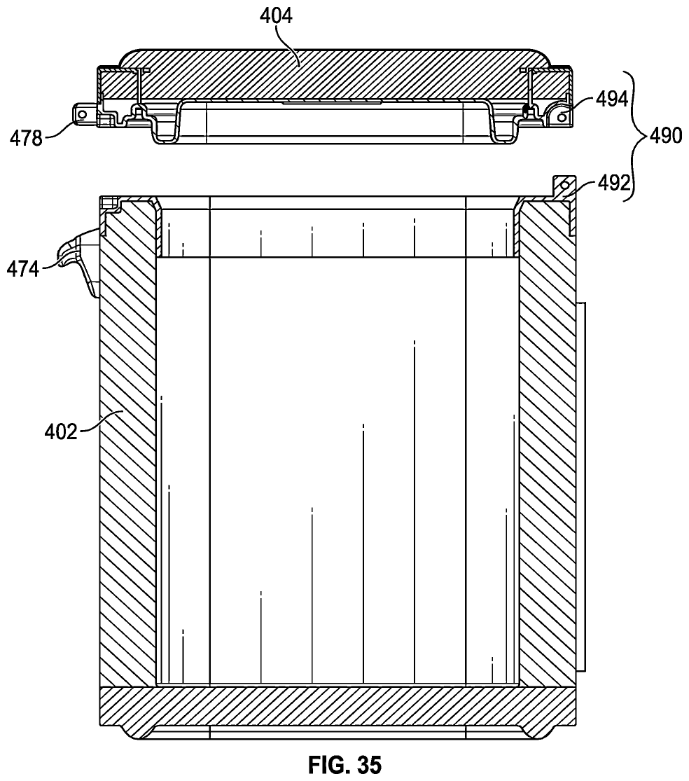

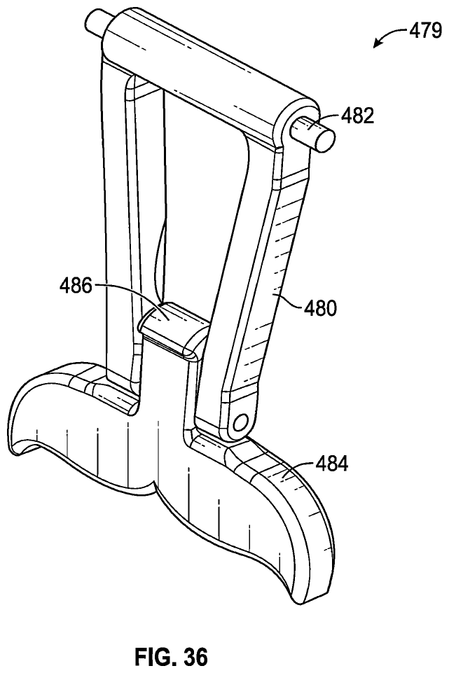

FIGS. 34 and 35 show the lid 404 decoupled from the housing 402. As shown, the lid 404 includes loop engagement points 478 along the front surface of the lid 404 for engagement with respective loop elements (e.g., loop elements 479). The lid 404 and housing 402 can couple along a rear of the insulating container 400 at a hinge assembly 490, where the hinge assembly 490 includes a housing hinge element 492 along the housing 402 and a lid hinge element 494 along the lid 404 that couple together. In the example of FIG. 36, the loop element 479 can define a body 480 having an engagement element 482 that couples with a respective loop engagement point (e.g., loop engagement point 478) to allow the loop element 479 to pivot with respect to the lid (e.g., lid 404). The loop element 479 can also include an end portion 484 that pivots with respect to the body 480 of the loop element 479 to enable a user to “unlock” the loop element 479 when opening the insulating container (e.g., insulating container 400). As shown, the end portion 484 can include a tab element 486 that couples with a respective hooked portion (e.g., hooked portion 474) of the housing (e.g., housing 402) and securely “locks” the lid against the housing when the end portion 484 is in substantial alignment with the body 480 of the loop element 479 and when the loop element 479 is coupled with the hooked portion. As such, a user can couple the loop element 479 with the hooked portion 474 and “press” the end portion 484 towards the sidewall of the housing to align the end portion 484 with the body 480 of the loop element 479; this motion causes the tab element 486 to engage the hooked portion 474 and apply a force that firmly and continually compresses the lid against the housing where the first engagement region and the second engagement region meet. In some aspects, this arrangement can tactile feedback to a user when closing the insulating container and ensures that the housing and the lid are coupled together. When opening the lid, the end portion 484 and tab element 486 can be rotated or otherwise pivoted substantially out of alignment with the body 480 of the loop element 479 to decouple the tab element 486 from the hooked portion and allow separation of the lid from the housing.

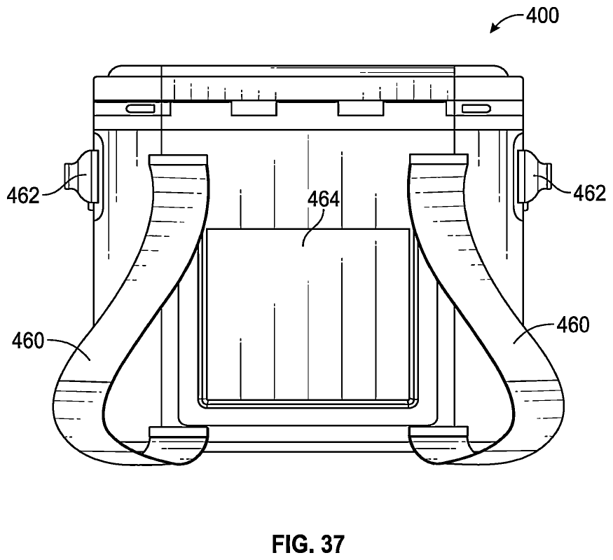

In some embodiments, dimensions of the insulating container (e.g., insulating container 100, 200, 300, and/or 400) are appropriately sized to function as a “cooler”; however other dimensions of the insulating container are contemplated that are appropriately sized to function as a “lunchbox”. It is appreciated that the insulating container may be modified to provide functionalities of other types of containers. For example, as shown in FIG. 37, the insulating container 400 can include features that allow the insulating container 400 to serve as a backpack having shoulder straps 460 positioned along a sidewall of the insulating container 400 as shown. Further, the example shown in FIG. 37 further shows side straps 462 positioned along opposing lateral sides of the insulating container 400, and can optionally include one or more pouches 464 along an exterior (and/or an interior) of the insulating container 400. Such an arrangement can similarly be applied to insulating containers 100, 200, 300 of FIGS. 1-30.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A container, including:
a housing having a first interference region;
a lid having a second interference region that engages the first interference region of the housing; and
a fastener assembly coupled to the housing and the lid that, when engaged, applies a force that presses the second interference region against the first interference region.

2. The container of claim 1, wherein the first interference region of the housing includes a shelf portion and wherein the second interference region of the lid is associated with a gasket having a first side that contacts the shelf portion and defines a gasket interference between the shelf portion and the first side of the gasket.

3. The container of claim 2, wherein the gasket includes a spine defined opposite to the first side, the spine engaging a gasket channel of the lid.

4. The container of claim 3, wherein the spine includes a plurality of tangs that engage a surface of the gasket channel.

5. The container of claim 1, wherein the first interference region of the housing includes a first angled surface and wherein the second interference region of the lid includes a second angled surface that contacts the first angled surface and defines a shell interference between the first angled surface and the second angled surface.

6. The container of claim 5, wherein a length of a vertical interference of the shell interference is greater than a length of a vertical interference of a gasket interference between a shelf portion of the first interference region and a first side of a gasket associated with the second interference region.

7. The container of claim 1, wherein the fastener assembly includes:
a loop element along the exterior surface of the lid that engages a hooked portion along the exterior surface of the housing.

8. The container of claim 7, wherein the loop element includes a body and an end portion that pivots with respect to the body, wherein the end portion includes a tab element that couples with the hooked portion and applies a force that presses the second engagement region of the lid against the first engagement region of the housing when the end portion is aligned with the body of the loop element.

9. The container of claim 7, wherein the fastener assembly includes a strap in association with the lid, wherein the strap includes the loop element and wherein the strap spans from a distal exterior surface of the housing to a proximal exterior surface of the housing.

10. The container of claim 7, wherein the fastener assembly includes a tensioning element configured to be tensioned by a tensioning device, wherein the tensioning element is coupled to the hook portion such that the hook portion is pulled in a first axial direction and applies a force that presses the second engagement region of the lid against the first engagement region of the housing as the tensioning element is tensioned by the tensioning device.

11. The container of claim 1, further comprising shoulder straps positioned along the housing.

12. A container, comprising:
a housing defining a sidewall and a first engagement region at an open portion along the sidewall of the housing, the first engagement region including:
a shelf portion in association with a gasket, wherein the gasket includes a first side that contacts the shelf portion and defines a gasket interference between the shelf portion and the first side of the gasket; and
a first angled surface defined interior to the shelf portion; and
a lid configured for engagement with the open portion of the housing, the lid including a second engagement region defined circumferentially about an interior surface of the lid, the second engagement region including:
a gasket channel configured to receive the gasket; and a second angled surface defined interior to the gasket
channel and configured to engage the first angled surface of the housing such that a shell interference is defined between the first angled surface and the second angled surface.

13. The container of claim 12, wherein a length of a vertical interference of the shell interference is greater than a length of a vertical interference of the gasket interference.

14. The container of claim 12, wherein the container includes a fastener assembly in association with an exterior surface of the lid and with an exterior surface of the housing.

15. The container of claim 14, further comprising a loop element along the exterior surface of the lid that engages a hooked portion along the exterior surface of the housing.

16. The container of claim 15, wherein the loop element includes a body and an end portion that pivots with respect to the body, wherein the end portion includes a tab element that couples with the hooked portion and applies a force that presses the second engagement region of the lid against the first engagement region of the housing when the end portion is aligned with the body of the loop element.

17. The container of claim 15, wherein the fastener assembly includes a strap in association with the lid, wherein the strap includes the loop element.

18. The container of claim 17, wherein the strap spans from a distal exterior surface of the exterior surface of the sidewall to a proximal exterior surface of the exterior surface of the sidewall.

19. The container of claim 15, wherein the hook element is associated with a hook base, the hook base being slidably mounted within a channel defined along the proximal exterior surface of the sidewall.

20. The container of claim 19, wherein the fastener assembly includes a tensioning element configured to be tensioned by a tensioning device, wherein the tensioning element is coupled to the hook base such that the hook base is pulled in a first axial direction as the tensioning element is tensioned by the tensioning device.

21. The container of claim 20, wherein the tensioning device includes a base and a rotatable dial at least partially encapsulating a spool rotatable by the dial, wherein the base is fixed within the channel of the sidewall, wherein the spool includes a tensioning element, wherein rotation of the dial in a first rotational direction winds the tensioning element about the spool.

22. The container of claim 14, wherein the fastener assembly comprises a zipper defined circumferentially about the perimeter of the container, wherein the zipper includes a slider element in association with a first tape and a second tape, wherein the first tape is coupled to the lid, the second tape is coupled to the sidewall portion, and wherein the first tape and the second tape are configured to be coupled by the slider element.
